(19) United States
(12) Patent Application Publication
(10) Pub. No.: US 2008/0310164 A1
(43) Pub. Date: Dec. 18, 2008

(54) Decorative Light

(76) Inventor: Xuliang Li, Dongguan (CN)

Correspondence Address: GLOBAL IP SERVICES, 7285 W. Eagle Court, Winton, CA, 95388, US

(21) Appl. No.: 11/875,832

(22) Filed: Oct. 20, 2007

(30) Foreign Application Priority Data
Jun. 18, 2007 (CN) 200720120771.X

(51) Int. Cl. F21S 13/14

(52) U.S. Cl. 362/252

(57) ABSTRACT

The present invention relates to a decorative light, and more particularly to a decorative model light that can generate light-reflecting effect for long. The decorative model light comprises illuminants, frames that shape certain sculpts, decorative strips that cover the frames. Said decorative strips are fixed on frames steadily, as the sculpt surface. Said decorative strips comprises core line and cover; said core line is made of metal or PET material, and light-reflecting layer is set on its surface; said cover is made of transparent PVC material. Said illuminants are LED bulbs, which join with holders, lead wires, and plugs as a string. The present invention provides a decorative model light that can generate light-reflecting effect for long, and can stand raining and sunbathing.

### CROSS REFERENCE TO THE RELATED PATENT APPLICATION

This application claims the priority of the Chinese patent application No. 200720120771.X with a filing date of Jun. 18, 2007.

### FIELD OF THE INVENTION

The present invention relates to a decorative light and more particularly to a decorative model light that can generate light-reflecting effect for long.

### BACKGROUND OF THE INVENTION

In our daily life, decorative lights can be seen here and there. Decorative model light in current market usually comprises a frame, illuminants (e.g. LED bulbs) set on the frame (e.g. tied on the frame), and gauzes or films covered on the frame. There are some decorative lights have light-reflecting material set on frame, but these lights can't generate decorative effect as the sheen lose after rained or sunburn.

### SUMMARY OF THE INVENTION

Accordingly, an object of the present invention is to provide a decorative model light that can generate light-reflecting effect for long.

To achieve the above-mentioned object, the present invention comprises: illuminants, frames that shape certain sculpts, and decorative strips that cover the frames. The decorative strips are fixed on frames steadily, as the sculpt surface; and the decorative strips comprises core lines and covers. The core lines are made of metals or PET material, and light-reflecting layer is set on their surfaces. The covers are made of transparent PVC material.

Preferably, said illuminants are LED bulbs, which join with holders, lead wires, and plugs as a string.

Preferably, said decorative strip's section shape is one of circle, rectangle, triangle, ellipse or quincunx. Said core line is at least one of metal line or PET line. Said decorative strip's section has at least one core line, and single core line's section shape is at least one of circle, triangle, ellipse or quincunx. Said light-reflecting layer is at least one of laser light-reflecting layer, colorful powder light-reflecting layer or light-reflecting plate.

Preferably, said decorative strip's section is flat rectangle, said core line is a metal line which section is flat, said light-reflecting layer is colorful light-reflecting powder set on the metal line surface.

Preferably, said decorative strip's section is circle, said core line is a PET line which section is triangle, said light-reflecting layer is laser light-reflecting layer set on the PET line surface.

Preferably, said decorative strip's section is flat rectangle; said core lines are two parallel metal lines, one is near one side of the flat rectangle, another is near another side of the flat rectangle; said light-reflecting layer is laser light-reflecting layer set on the metal line surface.

Preferably, said covers of decorative strips are made of soft transparent PVC material, said core lines are made of metals that can generate plastic deformation easily.

Preferably, said decorative strips are wringed and formed plastic deformation; said core lines are set on the frames helically.

Preferably, said frames have shapes as one of deer, snowman or Christmas tree.

Preferably, said LED bulbs strings are tied on the frames.

In the present invention, the decorative strips have transparent PVC covers and light-reflecting core line, keeping away from rain or sunbath direct damage, so as to generating light-reflecting effect for long. Shapes of decorative strips can be all kinds, such as circle, rectangle, triangle, ellipse or quincunx. Also, shapes of core lines can be all kinds, like circle, rectangle, triangle, ellipse or quincunx. And there can be more than one core line join together. So, these elements could combine to make many effects. Especially, after wring the decorative strips, the decorative lights generate more colorful light-reflecting effects, and keep the sheen for long.

### BRIEF DESCRIPTION OF THE DRAWINGS

FIG. 1 is a schematic view of an embodiment of a decorative strip according to the present invention.

FIG. 2 is a stereogram of an embodiment of a decorative light according to the present invention.

### DETAILED DESCRIPTION OF THE INVENTION

A preferred embodiment of the present invention will now be described.

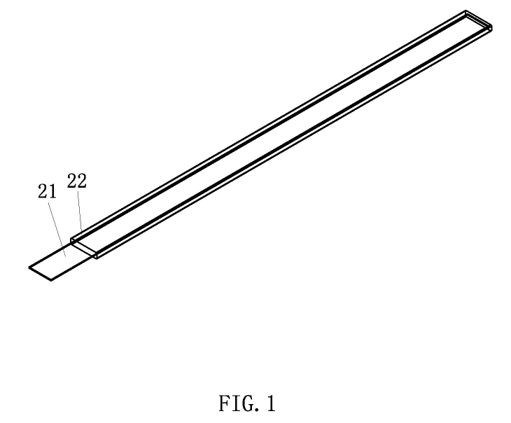

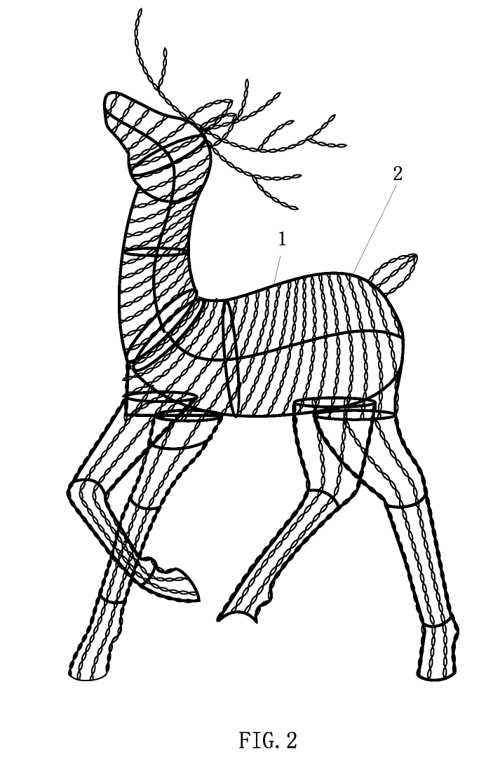

Referring to FIG. 1 and FIG. 2, an embodiment of the present invention is a decorative deer light, which comprises illuminants, frames 1 that shape deer sculpt, and decorative strips 2 that cover the frames 1; the decorative strips 2 fixed on frames 1 steadily, as the sculpt surface. The decorative strips 2 have the section as flat rectangle shape, and comprise core lines 21 and covers 22. The core lines 21 made of copper have flat rectangle section, and light-reflecting layer is set on its surface; and the covers 22 are made of transparent PVC material. The illuminants are LED bulbs, which join with holders, lead wires, and plugs as a string. FIG. 2 omits the LED string. The light-reflecting layer is set on the copper lines with colorful light-reflecting powder. The covers 22 of the decorative strips 2 are made of soft transparent PVC material, and the core lines 21 are made of copper that can generate plastic deformation easily. The decorative strips 2 in this embodiment are wringed and formed plastic deformation; the core lines 21 are tied on the frames 1 helically.

While the invention has been described in connection with what is presently considered to be the most practical and preferred embodiment, it is to be understood that the invention is not to be limited to the disclosed embodiments, but on the contrary, is intended to cover various modifications and equivalent arrangements included within the spirit and scope of the invention.

1. A decorative light, comprising:
Illuminants;
frame shaped certain sculpt;
decorative strips covering the frame;
wherein said decorative strips are fixed on said frame steadily as the sculpt surface; said decorative strip comprises core line and cover, said core line is made of metals or PET material, and light-reflecting layer is set on the surface of said core line; said cover is made of transparent PVC material.

2. The decorative light according to claim 1, wherein said illuminants are LED bulbs, which join with holders, lead wires, and plugs as a string.

3. The decorative light according to claim 1, wherein said decorative strip's section shape is one of circle, rectangle, triangle, ellipse or quincunx; said core line is at least one of metal line or PET line; said decorative strip's section has at least one core line, single core line's section shape is at least one of circle, triangle, ellipse or quincunx; said light-reflecting layer is at least one of laser light-reflecting layer, colorful powder light-reflecting layer or light-reflecting plate.

4. The decorative light according to claim 1, wherein said decorative strip's section is flat rectangle, said core line is a metal line which section is flat, said light-reflecting layer is colorful light-reflecting powder set on the metal line surface.

5. The decorative light according to claim 3, wherein said decorative strip's section is circle, said core line is a PET line which section is triangle, said light-reflecting layer is laser light-reflecting layer set on the PET line surface.

6. The decorative light according to claim 3, wherein said decorative strip's section is flat rectangle;
said core lines are two parallel metal lines, one is near one side of the flat rectangle, another is near another side of the flat rectangle; said light-reflecting layer is laser light-reflecting layer set on the metal line surface.

7. The decorative light according to claim 1, wherein said covers of decorative strips are made of soft transparent PVC material, said core lines are made of metals that can generate plastic deformation easily.

8. The decorative light according to claim 7, wherein said decorative strips are wringed and formed plastic deformation; said core lines are set on the frames helically.

9. The decorative light according to claim 8, wherein said frames have shapes as one of a deer, snowman or Christmas tree.

10. The decorative light according to claim 2, wherein said LED bulbs strings are tied on the frames.
